(19) United States
(12) Patent Application Publication
(10) Pub. No.: US 2003/0041441 A1
(43) Pub. Date: Mar. 6, 2003

(54) Method of manufacturing silicon steel sheets for current-resistant coils

(76) Inventor: Kuo-Liang Lin, Chia-Yi Hsien (TW)

Correspondence Address: BACON & THOMAS, PLLC, 625 SLATERS LANE, FOURTH FLOOR, ALEXANDRIA, VA, 22314

(21) Appl. No.: 09/940,889

(22) Filed: Aug. 29, 2001

(51) Int. Cl. H01F 7/06; B23P 11/00

(52) U.S. Cl. 29/605; 29/432

(57) ABSTRACT

A method of manufacturing silicon steel sheets for current-resistant coils comprises the steps of: transporting a silicon steel sheet material with the directional property to a punching machine, punching the silicon steel sheet material to form a formed first silicon steel sheet and a formed second silicon steel sheet which have directional property normal to the formed first silicon steel sheet and the formed second silicon steel sheet, and winding a coil on the formed second silicon steel sheet. When power supply is input, the coil and the formed first silicon steel sheet and the formed second silicon steel sheet will generate a magnetic force direction normal to the directional property of the silicon steel sheet material. Thus the current-resistant coil can withstand greater input power supply, deliver more stable output and better meet PFC requirements.

### FIELD OF THE INVENTION

The present invention relates to a method of manufacturing silicon steel sheets for current-resistant coils and particularly silicon steel sheets that have directional property normal to magnetic force direction to allow current-resistant coils withstanding greater power supply input.

### BACKGROUND OF THE INVENTION

Current-resistant coils are widely used in various types of electric devices. They also play important role in the power supply of electric products. They are mainly used to increase energy utilization efficiency and reduce unnecessary energy consumption. Besides to increase durability of electric devices, they also serve environment protection purpose. Hence current-resistant coils have increasingly become indispensable but easy to use elements in electric products.

A conventional current-resistant coil, as shown in FIG. 1, in general, is made by punching a silicon steel sheet material which has directional property 1a by means of punching machines to become formed silicon sheets 5a, 6a. The finished formed silicon sheets 5a, 6a have directional property 1a in parallel with the original silicon steel sheet 5a, 6a. Then the silicon steel sheet 6a is connected to a coil seat (not shown in the drawing) which is wound by a coil 7a. Then the silicon sheets 5a, 6a are coupled to become a current-resistant coil.

When the current-resistant coil receives input power supply, electric current flows on the coil 7a, the interaction of the coil 7a and the silicon steel sheets 5a, 6a generates magnetic force direction 8a which is in parallel with the directional property 1a of the steel sheet material. As a result, the coil is unable to withstand greater input power supply and output often become unstable.

### SUMMARY OF THE INVENTION

The primary object of the invention is to resolve the foregoing disadvantages. The invention aims to provide an improved design for silicon steel sheets to allow current-resistant coils withstanding greater input power supply to better meet PFC requirements.

Another object of the invention is to utilize smaller number of silicon sheets to decrease production costs and also to make production easier.

A further object of the invention is to decrease the weight and shrink the size of the current-resistant coils.

In order to achieve the foregoing objects, the method of the invention includes: punching a silicon steel sheet material which has directional property through punching machines to become a first and a second silicon sheet of selected forms which have directional property normal to the silicon steel sheet material; then winding the second silicon sheet with a coil. When power supply is input, the magnetic force direction generated by the coil and the formed first and second silicon steel sheet is normal to the directional property of the silicon steel sheet material, thus the current-resistant coil can withstand greater input power supply and output will become more stable.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional current-resistant coil.

FIG. 2 is a schematic view of a silicon steel sheet material of the invention having directional property.

FIG. 3 is a schematic view of punch mold positions for punching silicon steel sheet of the invention.

FIG. 4 is a schematic view of the silicon steel sheets after formed.

FIG. 5 is a schematic view of the silicon steel sheet of the invention wound with a coil for use.

FIGS. 6A and 6B are chart and table of test results of conventional silicon steel sheets with horizontal directional property and are in parallel with magnetic force direction, using 55 silicon steel sheets.

FIGS. 7A and 7B are chart and table of test results of an embodiment of the invention with vertical directional property and normal to the magnetic force direction, using 55 silicon steel sheets.

FIGS. 8A and 8B are chart and table of test results of another embodiment of the invention with vertical directional property and normal to the magnetic force direction, using 45 silicon steel sheets.

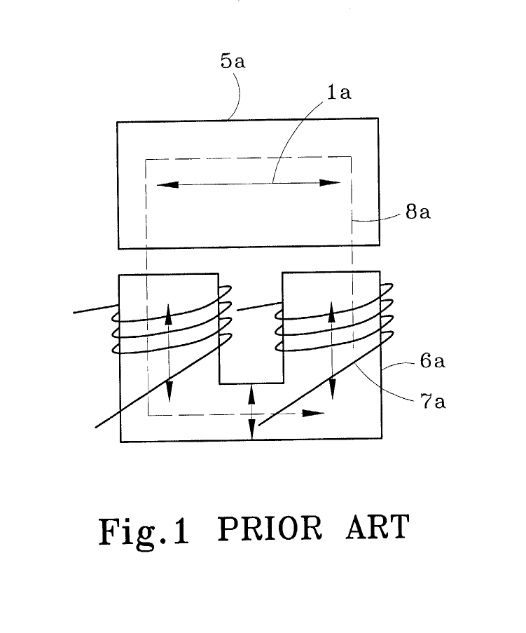

### DESCRIPTION OF THE PREFERRED EMBODIMENT

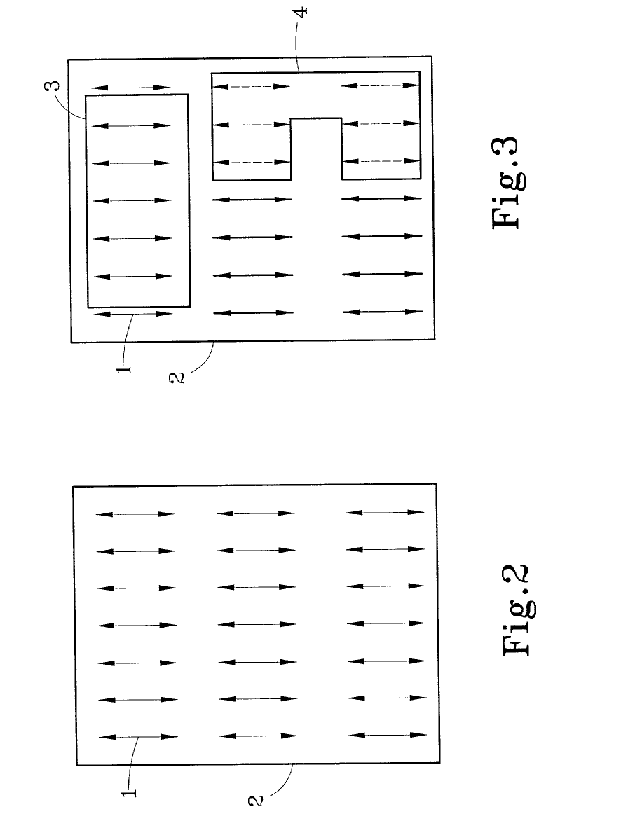

Referring to FIGS. 2, 3 and 4, the method of the invention aims to produce silicon steel sheets with directional property normal to magnetic force direction thereby to allow current-resistant coils withstanding greater input power supply to better meet PFC requirements.

The method of making the silicon steel sheets according to the invention includes the steps of:

1. transport a silicon steel sheet material 2 with a directional property 1 to a punching machine (not shown in the drawings);

2. setup a first mold 3 and a second mold 4 for punching the silicon steel sheet material 2 to become a formed first silicon steel sheet 5 and a formed second silicon steel sheet 6;

3. the formed first silicon steel sheet 5 and the formed second silicon steel sheet 6 thus made have directional property 1 which is normal to the formed first silicon steel sheet 5 and the formed second silicon steel sheet 6.

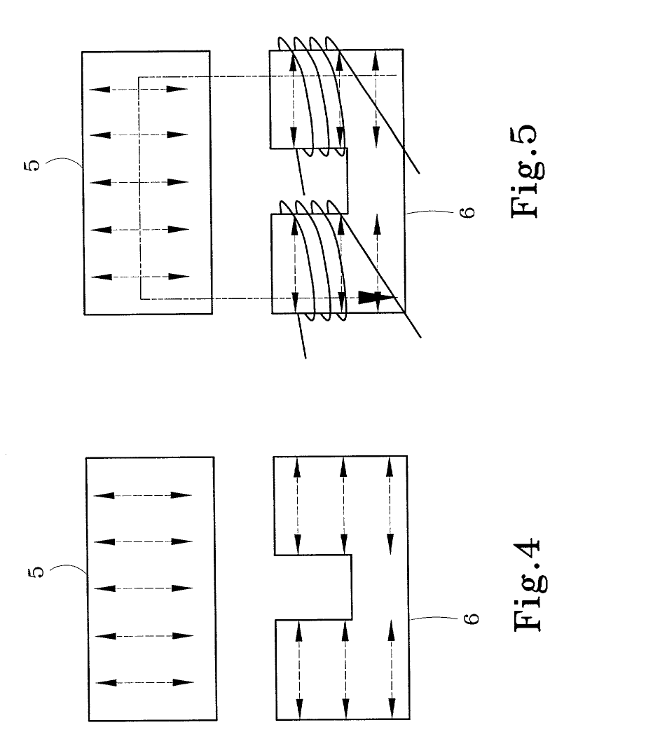

Referring to FIGS. 4 and 5, after the formed first silicon steel sheet 5 and the formed second silicon steel sheet 6 are made, connect the formed second silicon steel sheet 6 to a coil seat (not shown in the drawing) which is wound with a coil 7, then couple the formed first silicon steel sheet 5 and the formed second silicon steel sheet 6 to complete the current-resistant coil.

When the current-resistant coil receives input power supply, electric current will flow on the coil 7, the magnetic force direction generated by the coil 7 and the formed first and second silicon steel sheet 5, 6 is normal to the directional property 1 of the silicon steel sheet material 2, rather than the parallel condition of magnetic force direction relative to the directional property 1 of the silicon steel sheet material 2 of the conventional ones, hence the coil 7 can withstand greater input power supply and better meet PFC requirements.

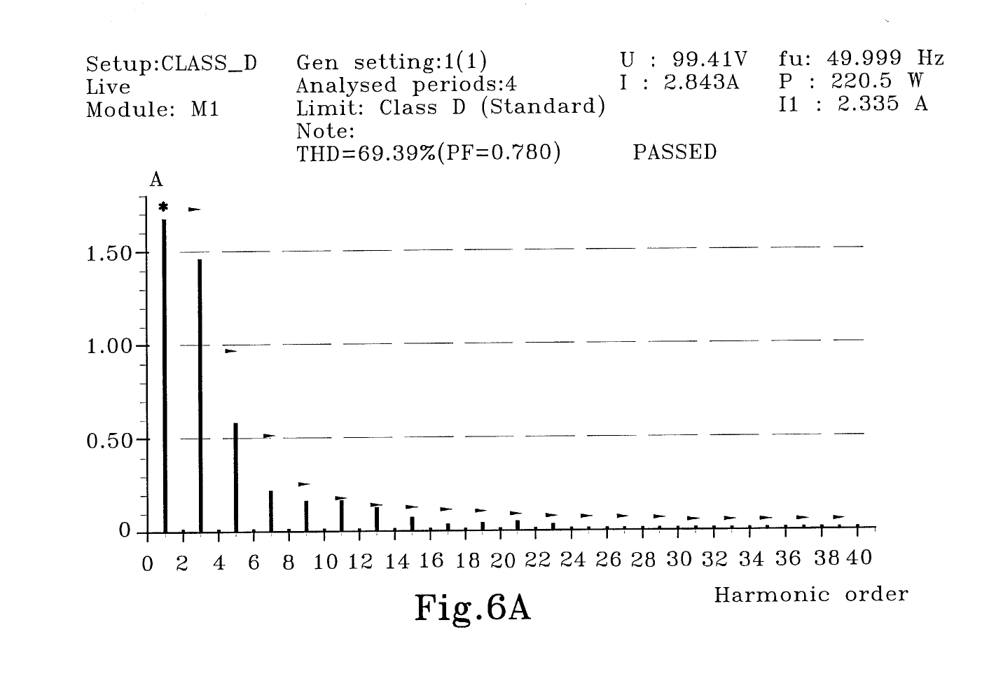

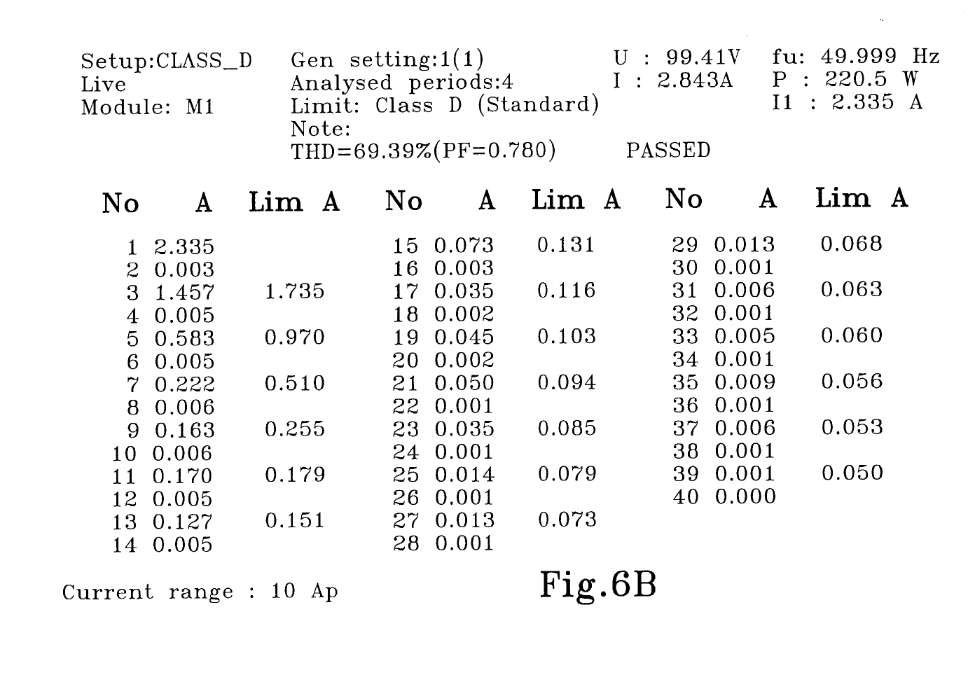

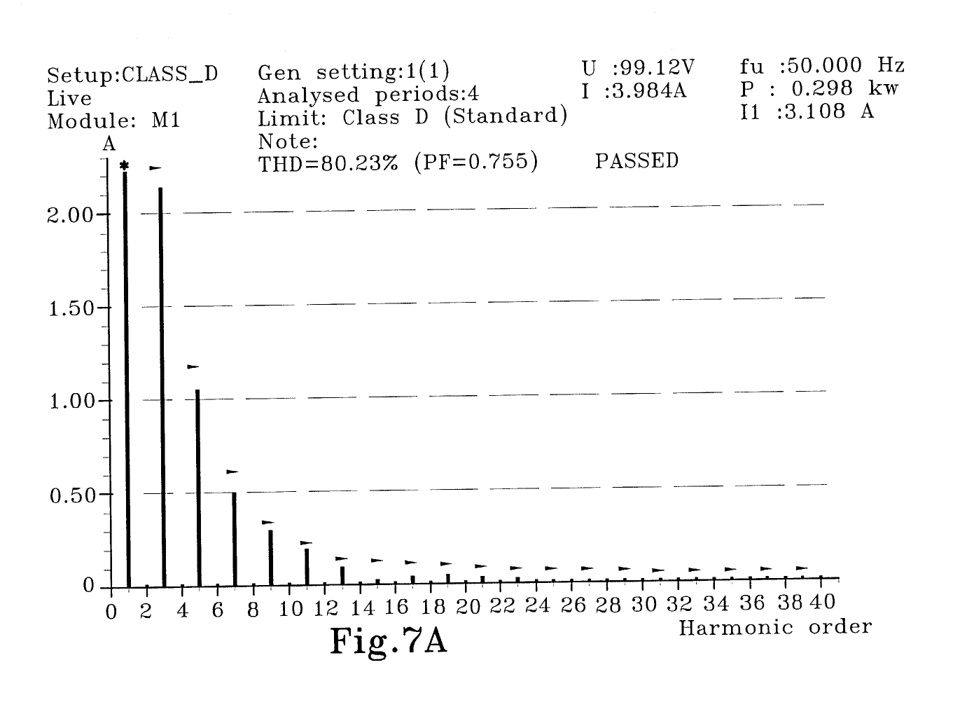

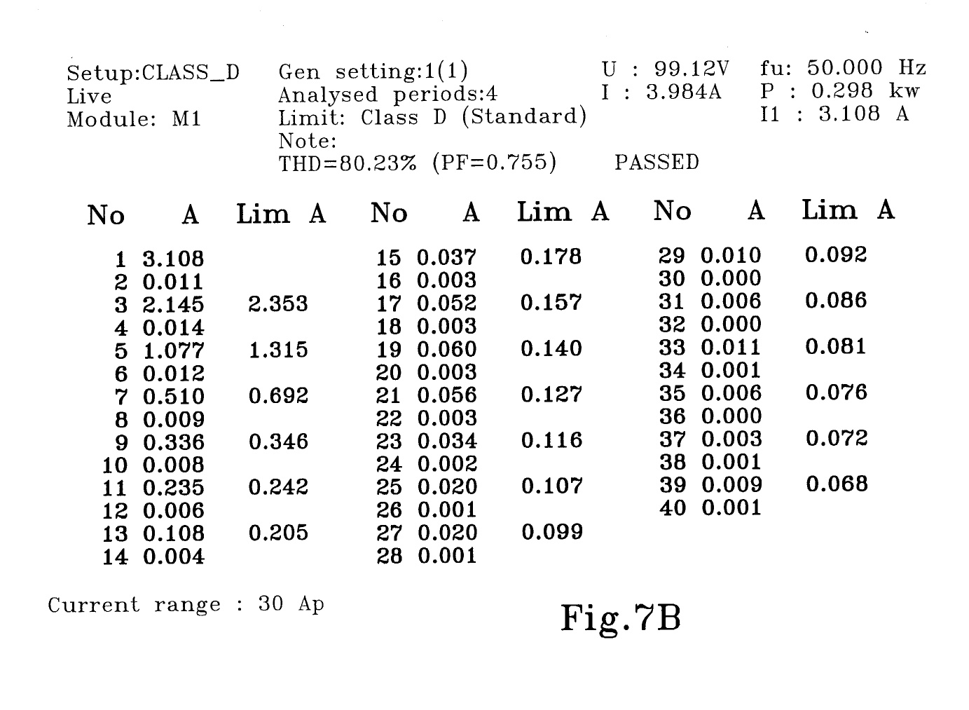

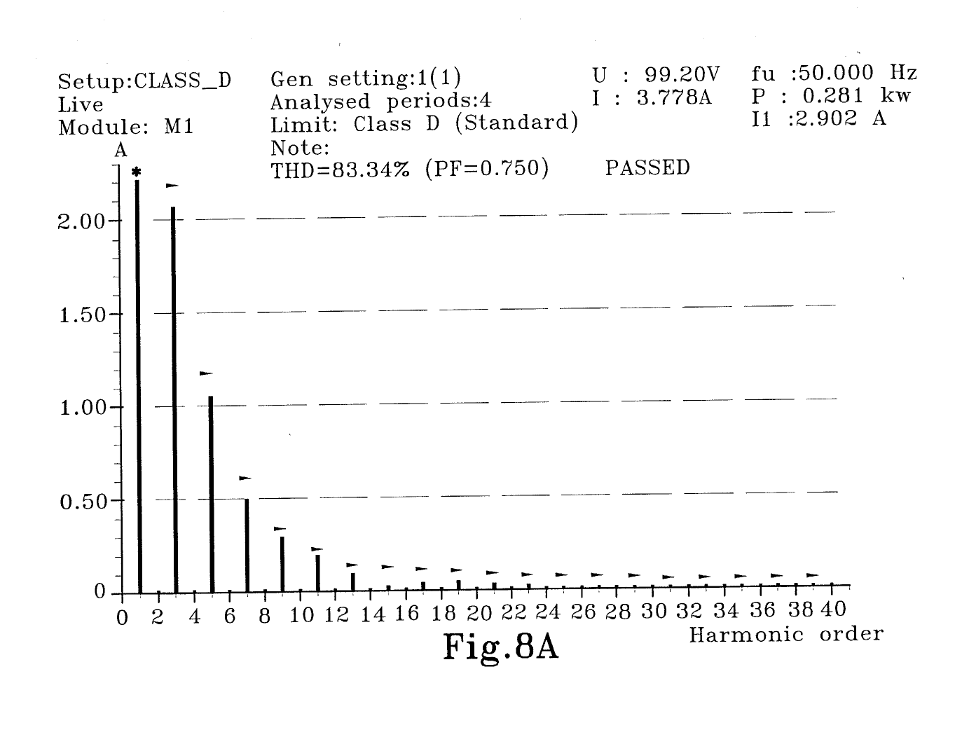

Referring to FIGS. 6A, 6B, 7A and 7B for comparisons of test results of conventional structure and the invention based on fifty five pieces of silicon steel sheets. The current-resistant coil is conformed to the minimum PFC requirements of 75 W and went through pass harmonic testing.

When testing with equal number of silicon steel sheets, the conventional one has the directional property 1 of the silicon steel sheet material 2 in parallel with the magnetic force direction 8 while the invention has the directional property 1 of the silicon steel sheet material 2 normal to the magnetic force direction 8. Test results show that the invention has better performance than the conventional one, thus can withstand greater input power supply and may deliver more stable output.

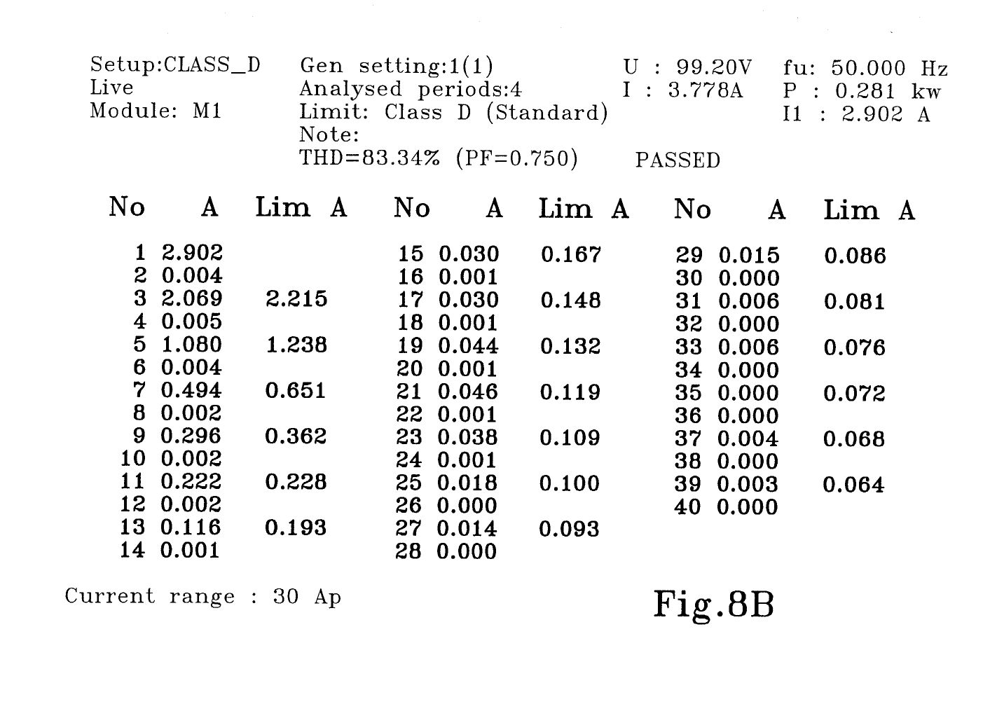

Referring to FIGS. 7A, 7B, 8A and 8B for comparisons of test results of the invention based on fifty five and fourth five pieces of silicon steel sheets, with the directional property 1 of the silicon steel sheet material 2 normal to the magnetic force direction 8. Test results show that both have substantially same level of performance even the numbers of silicon steel sheets are different. Thus adopting the design of the invention by deploying the directional property 1 of the silicon steel sheet material 2 normal to the magnetic force direction 8, a smaller number of silicon steel sheets may be used to reduce production costs, and may result in lighter weight and smaller size of the current-resistant coil.

In addition to the formed silicon steel sheets shown in the previous discussions, the silicon steel sheets may be formed in any other shapes desired as long as the directional property 1 of the silicon steel sheet material 2 is normal to the magnetic force direction 8.

What is claimed is:

1. A method of manufacturing silicon steel sheets for current-resistant coils to make a directional property of the silicon steel sheets normal to the magnetic force direction for the current-resistant coils to withstand greater input power supply, deliver more stable output, and meet PFC requirements, the method comprising the steps of:
a. transporting a silicon steel sheet material with the directional property to a punching machine;
b. punching the silicon steel sheet material to form a formed first silicon steel sheet and a formed second silicon steel sheet;
c. coupling the formed first silicon steel sheet and the formed second silicon steel sheet such that the directional property of the formed first silicon steel sheet and the formed second silicon steel sheet being normal to the formed first silicon steel sheet and the formed second silicon steel sheet; and
d. winding a coil on the formed second silicon steel sheet such that when power supply is input the coil and the formed first silicon steel sheet and the formed second silicon steel sheet generating a magnetic force direction normal to the directional property of the silicon steel sheet material.

2. The method of claim 1, wherein the silicon steel sheets are formed in selected shapes and have the directional property thereof normal to the magnetic force direction.
